(19) United States
(12) Patent Application Publication
(10) Pub. No.: US 2017/0091256 A1
(43) Pub. Date: Mar. 30, 2017

(54) Record Retention and Deletion

(71) Applicant: Bank of America Corporation, Charlotte, NC (US)

(72) Inventors: Candace Gordon, Jacksonville, FL (US); Katherine E. Brown, Jacksonville, FL (US); Frank A. Luther, Jacksonville, FL (US); Aruna V. Kamath, Jacksonville, FL (US); Vaithyanathan Ramanathan, Jacksonville, FL (US); Ann Charlot Hunaes Harvey, Iron Station, NC (US); Lynne M. Sommer, Jacksonville, FL (US); Daniel P. McCoy, St. Augustine, FL (US); Robert J. Nicholson, Matthews, NC (US)

(21) Appl. No.: 14/869,639

(22) Filed: Sep. 29, 2015

(51) Int. Cl. G06F 17/30; G06F 3/06

(52) U.S. Cl. CPC G06F 17/30371; G06F 17/30011; G06F 3/0608; G06F 3/0652; G06F 3/067

(57) ABSTRACT

Methods, systems, and computer-readable media for determining expiration of a retention period for a document or record and deleting records or documents are provided. In some examples, a record code may be assigned to a record. The record code may indicate a retention period for the record and may be used to determine whether the retention period has expired. If so, a determination may be made as to whether the document is eligible for deletion. If so, the record may be automatically deleted in at least some examples. If not, the record may be further processed.

### BACKGROUND

Aspects of the disclosure relate to computer hardware and software. In particular, one or more aspects of the disclosure generally relate to computer hardware and software for determining a retention period of a record and, in at least some examples, automatically deleting the record upon expiration of the retention period.

Organizations, such as corporate entities and other large enterprise organizations, may often manage storage (e.g., archiving) of various documents, databases, or other records. In large entities, the number of documents being stored may be tremendous. Further, entities often have predetermined retention periods for which they will maintain one or more documents or types of documents. These retention periods may be defined by the entity or, in some industries by an overseeing body, such as a government entity. Ensuring that large quantities of documents are stored and retained for the appropriate time period can be time consuming, inefficient and prone to errors (e.g., retention of documents well beyond the designated retention period).

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to computer systems that provide effective, efficient, and convenient ways of managing archived documents and ensuring deletion upon expiration of a retention period. For example, one or more aspects of the disclosure relates to generating a plurality of record codes. Each record code may be associated with a retention period. A record code may be assigned to each record being stored to designate the appropriate retention period for that record.

In some examples, the system (e.g., a record retention engine computing platform) may determine whether the retention period for a particular record has expired (e.g., based on the record code assigned to that record). If so, the record may be identified as having an expired retention period. The record (or an identification of the record) may be transmitted to a second computing platform, such as a record and information management computing platform, for a determination of whether the record should be deleted or whether a flag or other hold has been assigned to the record. In some examples, determining whether the record should be deleted may include determining whether the record is eligible for automatic deletion.

If the record is eligible for deletion, the record and information management computing platform may transmit an instruction to the record retention engine computing platform to delete the identified record. Accordingly, the record may be deleted (e.g., automatically). In some examples, deletion of the record may include holding the record for a predefined time period and, upon expiration of the time period, automatically deleting the record.

If the record is not eligible for deletion, the record and information management computing platform may transmit an instruction to the record retention engine computing platform to perform further processing on the record. Further processing may include forwarding the record for a manual review prior to deletion, placing a temporary hold on deletion of the record, or the like.

In some examples, a date from which the expiration of the retention period may be determined may be automatically provided by the system (e.g., a record may be assigned a date on which it was archived or uploaded to the system). In other examples, the date may be manually adjusted (e.g., by a system administrator). In still other examples, the record retention engine computing platform may query a record to determine whether date content exists within the record. If so, the system may determine whether the date content in the record pre-dates the date assigned by the system. If so, the date maybe modified to the earlier date.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative operating environment in which various aspects of the disclosure may be implemented in accordance with one or more aspects described herein;

FIG. 2 depicts an illustrative block diagram of workstations and servers that may be used to implement the processes and functions of certain aspects of the present disclosure in accordance with one or more aspects described herein;

FIG. 3 depicts illustrative computing platforms for determining whether a retention period of a record has expired and deleting records having an expired retention period in accordance with one or more aspects described herein;

FIGS. 4A and 4B depict an illustrative event sequence for assigning a record code to a record and identifying records for which a retention period has expired in accordance with one or more aspects described herein.

FIGS. 5A-5B depict an illustrative event sequence for receiving records identified as having an expired retention period and processing the records for deletion according to one or more aspects described herein;

FIG. 6 depicts an illustrative method for identifying one or more records for which a retention period has expired, according to one or more aspects described herein;

FIG. 7 depicts an illustrative method for deleting or further processing records for which a retention period has expired according to one or more aspects described herein; and

FIG. 8 depicts an illustrative method for evaluating and potentially modifying a date associated with a record according to one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, entities, such as corporations, government entities, universities, and the like, often implement record retention policies. In some industries, one or more retention policy may be required by a governing body or government agency. However, many business entities employ some type of retention policy which identifies when a particular record, or type of record, should or may be deleted. A record may include documents, databases, and various other types of data. In large entities, managing the records, identifying records with an expired retention period, and the like, can be time-consuming, costly, and inefficient, and may also lead to mistakes or other inaccuracies. Accordingly, the arrangements described herein relate to systems and methods of managing records, identifying retention periods, identifying records with an expired retention period and deleting documents that have been held beyond the prescribed retention period. Some or all of the aspects of the systems and arrangements described herein may be performed automatically, as will be discussed below. These and other aspects will be discussed more fully herein.

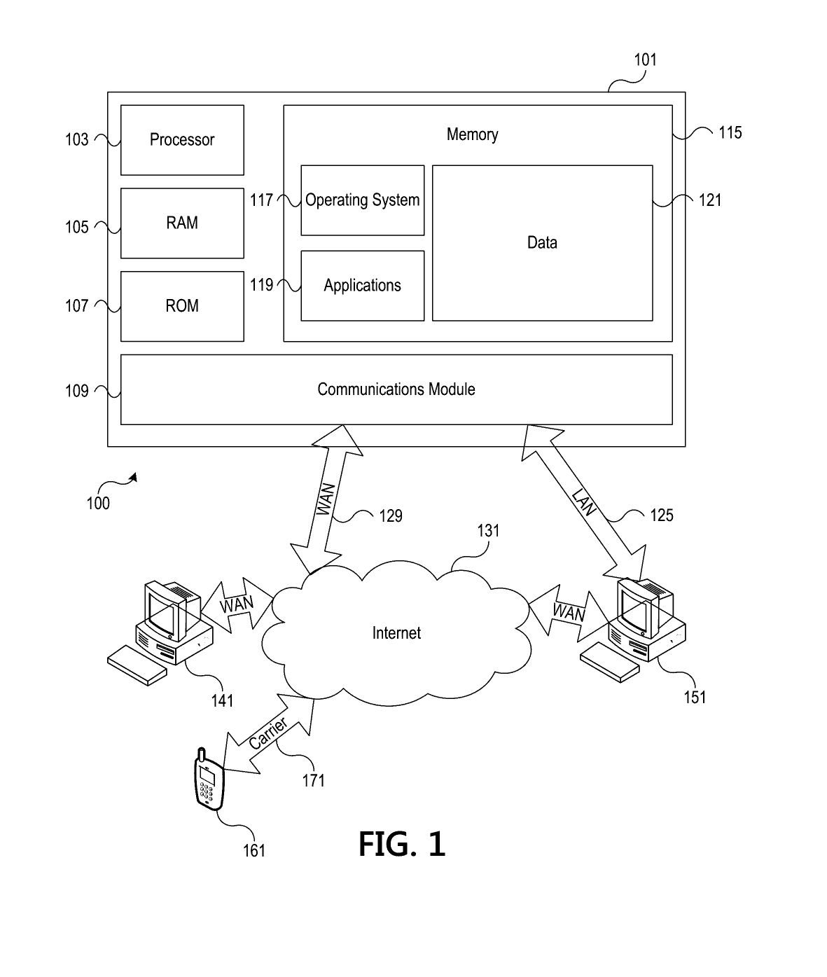

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks) are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

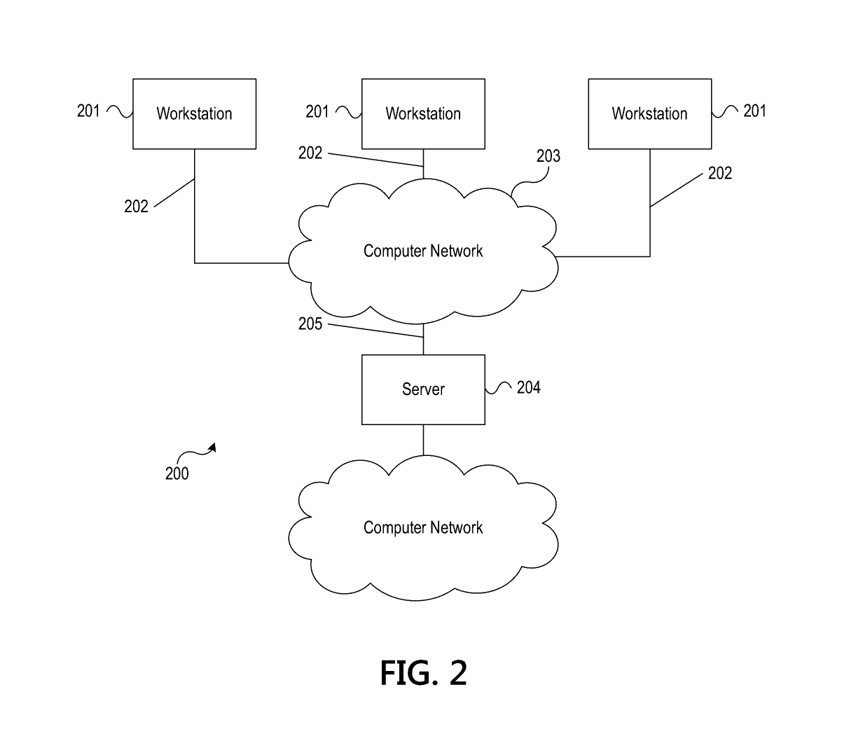

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

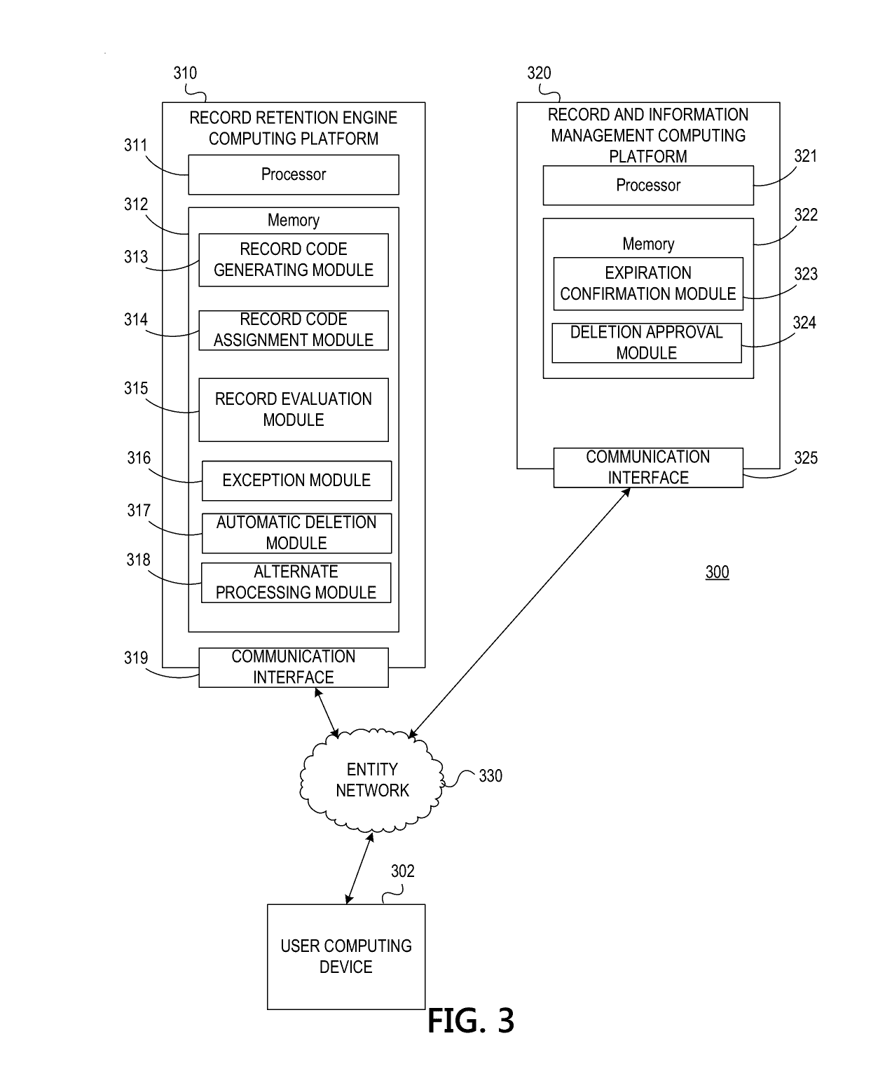

FIG. 3 depicts an environment 300 including illustrative computing platforms for determining record retention periods, identifying records for which the retention period has expired, and/or deleting records for which the retention period has expired, according to one or more aspects described herein. For instance, the environment 300 includes a record retention engine computing platform 310, which may include one or more processors 311, memory 312, and communication interface 319. A data bus may interconnect processor(s) 311, memory 312, and communication interface 319. Communication interface 319 may be a network interface configured to support communication between record retention engine computing platform 310, record and information management computing platform 320, and one or more networks (e.g., network 330). Memory 312 may include one or more program modules having instructions that when executed by processor(s) 311 cause record retention engine computing platform 310 to perform one or more functions described herein and/or one or more databases that may store and/or otherwise maintain information which may be used by such program modules and/or processor(s) 311. In some instances, the one or more program modules and/or databases may be stored by and/or maintained in different memory units of record retention engine computing platform 310 and/or by different computer systems that may form and/or otherwise make up the record retention engine computing platform 310.

For example, memory 312 may include a record code generating module 313. The record code generating module 313 may include hardware and/or software configured to perform various functions within the record code retention engine computing platform. For instance, the record code generating module 313 may generate and/or store (e.g., in a database within the module) one or more record codes identifying a retention period for a record. For instance, record codes such as one year, five years, seven years, or ten years may be generated and may be used to indicate that a record associated with a particular record code will (or should) be retained for the retention period associated with the record code.

In some examples, a user, such as an administrator of the system, may request a new record code (e.g., a record code indicating a retention period not previously associated with a record code). In such arrangements, the user may access the record code generating module 313 (e.g., via user computing device 302 and entity network 330) to request and/or create the desired record code. The newly created record code may then be stored (e.g., in a database associated with the record code generating module 313) for additional or later use.

The record retention engine computing platform 310 may further include a record code assignment module 314. The record code assignment module 314 may include hardware and/or software configured to perform various functions within the record retention engine computing platform 310. For instance, the record code assignment module 314 may determine a retention period for a particular record (e.g., based on a type of record, content of the record, and the like) and may assign a record code associated with that retention period to the record. The record and assigned retention code may then be stored (e.g., together) for use and/or to await deletion upon expiration of the retention period.

The record retention engine computing platform 310 may further include record evaluation module 315. The record evaluation module 315 may include hardware and/or software configured to perform various functions within the record retention engine computing platform 310. For instance, the record evaluation module 315 may evaluate one or more records and assigned record codes within the record retention engine computing platform 310 to determine whether the retention period has expired. For instance, when a record is archived (e.g., provided to the record retention engine computing platform 310) a date on which the record is archived may be stored with the record. Accordingly, the record evaluation module 315 may retrieve the date on which the record was archived and determine a difference between the archive date and a current date. If this difference is greater than the retention period associated with the record code assigned to the record, then the retention period has expired and the record should be removed or deleted.

In some arrangements, the date on which the record was archived might not be the most accurate date from which to calculate the retention period. For instance, if the record was created and stored in another medium and then uploaded to the record retention engine computing platform 310, the archive date provided by the platform 310 may be the date the record was uploaded. However, a more accurate date from which to calculate the retention period may be earlier than that (e.g., a date on which the record was created, a date on which the record was archived to the other medium, or the like). Accordingly, the record retention engine computing platform 310 may include an exception module 316.

The exception module 316 may include hardware and/or software configured to perform various functions within the record retention engine computing platform 310. For instance, in some examples, a user, such as a system administrator, may be aware of the earlier date from which the retention date should be calculated. Accordingly, the user may override the date associated with the record in the platform 310 to instead assign the earlier date to the record.

In another example, the exception module 316 may query the data within a record to determine whether date information is provided within the record (e.g., within content of the record). If so, the exception module 316 may determine whether the date information within the record matches (or is within a predefined threshold of) or pre-dates the archive date provided by the platform 310. If the record matches the date provided by the platform, no changes may be made to the date of the record. If not (e.g., if the date within content of the record pre-dates the date provided or identified by the platform 310, the exception module may automatically modify the date associated with the record to the earlier or alternate date (e.g., the date identified within the record). In some example, any modifications may be logged, tracked and/or stored such that a report (such as a reporting table of modified records) may be generated indicating changes made to date, records affected, and the like.

Records identified as having an expired retention period may be transmitted to a record and information management computing platform 320 (e.g., via an entity network). For instance, once a record is identified as having an expired retention period, the record or identification of the record may be provided to the record and information management computing platform 320 for processing. Providing the record or identification of the record may include adding the record to a file of records having an expired retention period that may be transmitted to the record and information management computing platform 320.

The record and information management computing platform 320 may include one or more processors 321, memory 322, and communication interface 325. A data bus may interconnect processor(s) 321, memory 322, and communication interface 325. Communication interface 325 may be a network interface configured to support communication between record retention engine computing platform 310, record and information management computing platform 320, and one or more networks (such as network 330). Memory 322 may include one or more program modules having instructions that when executed by processor(s) 321 cause record and information management computing platform 320 to perform one or more functions described herein and/or one or more databases that may store and/or otherwise maintain information which may be used by such program modules and/or processor(s) 321. In some instances, the one or more program modules and/or databases may be stored by and/or maintained in different memory units of record and information management computing platform 320 and/or by different computer systems that may form and/or otherwise make up the record and information management computing platform 320.

As discussed above, in some arrangements, records identified as having an expired retention period may be transferred or transmitted from the record retention engine computing platform 310 to the record and information management computing platform 320 for further processing. For example, memory 322 may include an expiration confirmation module 323. The expiration confirmation module 323 may include hardware and/or software configured to perform various functions within the record and information management computing platform 320. For instance, the expiration confirmation module 323 may confirm the determination that the difference between a current date and a date associated with a record is greater than a retention period and, thus, that the record's retention period has expired.

The memory 322 may further include a deletion approval module 324. The deletion approval module may include hardware and/or software configured to perform various functions within the record and information management computing platform 320. For instance, the deletion approval module 324 may analyze the records identified as having an expired retention period (or file including the records) to determine whether the record is eligible for automatic deletion. In some examples, determining whether a record is eligible for automatic deletion may include determining whether a flag or hold has been placed on the record. For instance, a legal department of an entity may desire to retain a record beyond the prescribed retention period. If so, the record may include a flag or hold and, instead of being automatically deleted, may be further processed.

Once a determination is made as to whether a record is eligible for automatic deletion, the record and information management computing platform 320 may transmit an instruction to the record retention engine computing platform 310 regarding the outcome of the determination. For instance, memory 312 may include an automatic deletion module 317. The automatic deletion module 317 may include hardware and/or software configured to perform various functions within the record retention engine computing platform 310. For instance, the automatic deletion module 317 may receive an instruction (e.g., from record and information management computing platform 320) that the record may be automatically deleted. In some examples, automatic deletion of a record may include holding the record for a predetermined time period and, upon expiration of the time period, automatically deleting the record (e.g., executing a deletion procedure on the record).

If the record is not eligible for automatic deletion, an instruction may be transmitted to the record retention engine computing platform 310 to further process the record. For instance, memory 312 may include an alternate processing module 318 which may include hardware and/or software configured to perform various functions within the record retention engine computing platform 310. For instance the alternate processing module 318 may forward a record to a manual review process, may flag a record to be reviewed by the system again prior to deletion, may forward a record identified for deletion to a log or other report which may be reviewed, either automatically by one or more devices within the system, or manually prior to deletion. Various other types of alternate processing may be performed without departing from the invention.

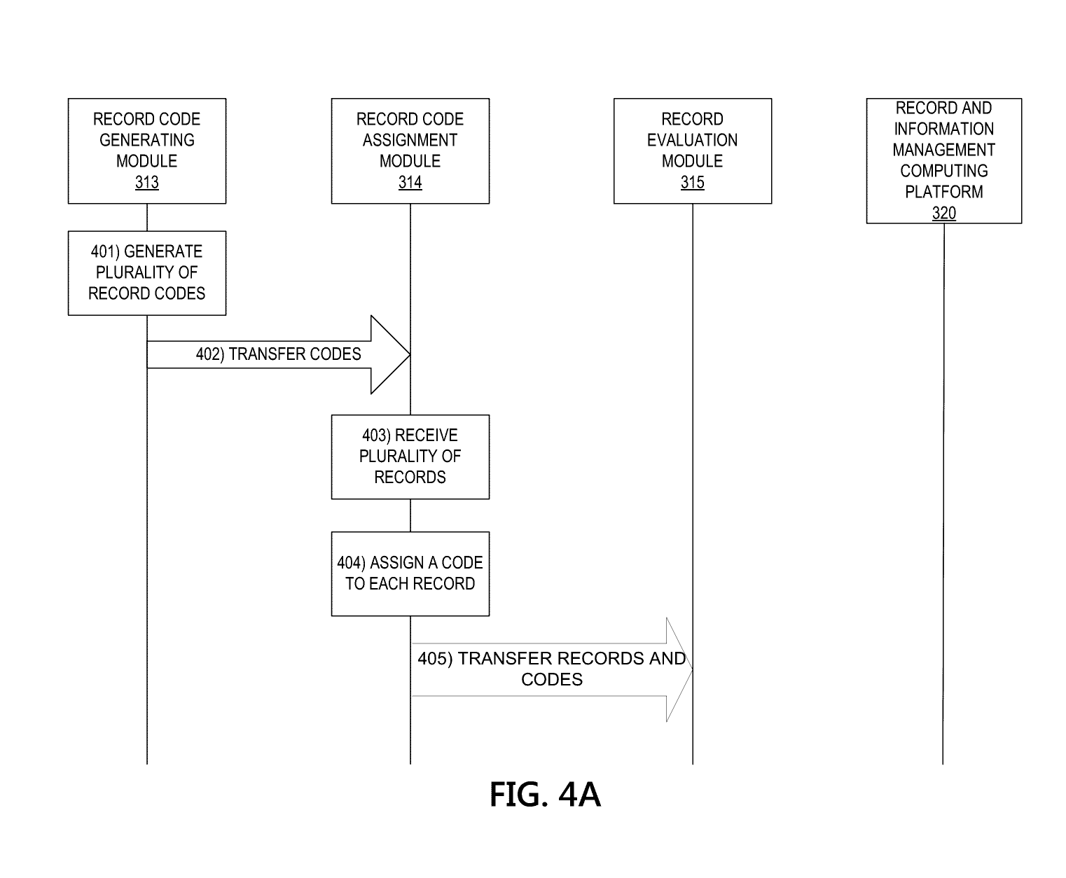

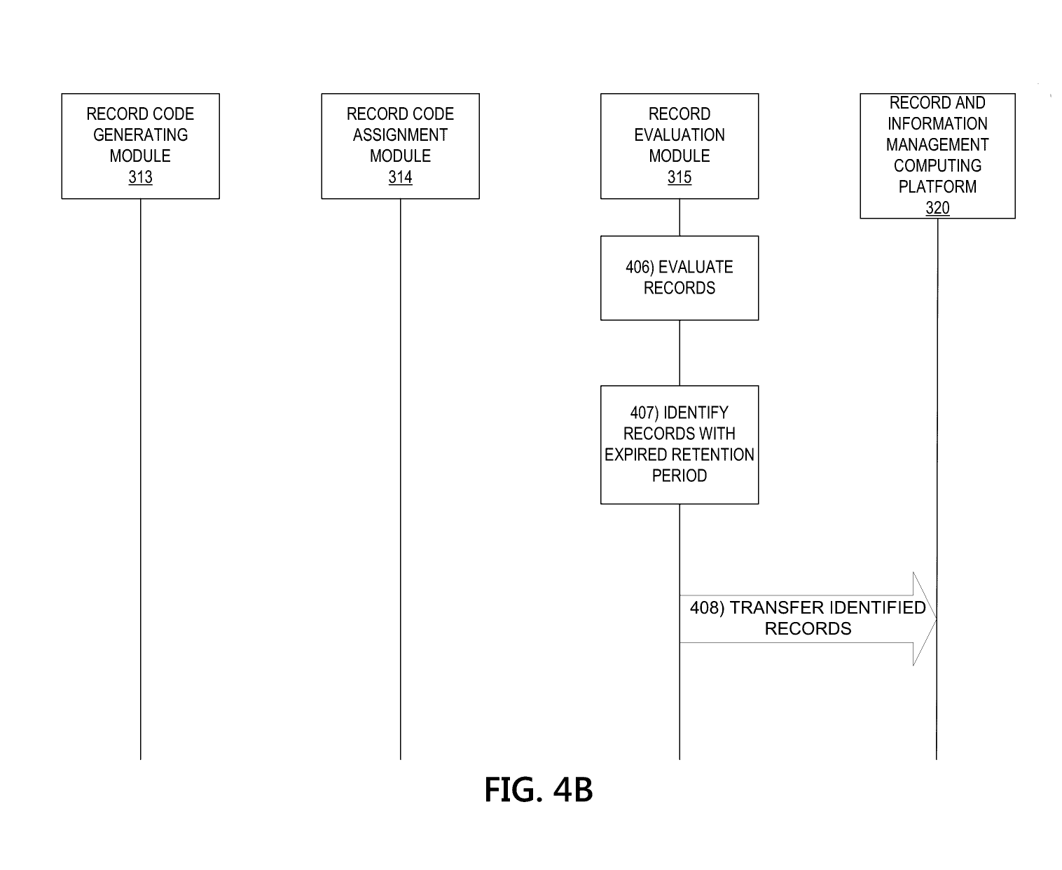

FIGS. 4A-4B depict an illustrative event sequence for assigning a record code to a record and identifying records for which a retention period has expired according to one or more aspects described herein. It should be noted that the events shown and described with respect to FIGS. 4A and 4B are merely one example sequence and some steps may be omitted, or additional steps added, without departing from the invention.

With reference to FIG. 4A, in step 401, a plurality of record codes may be generated (e.g., by a record code generating module 313). As discussed above, the record codes may be associated with a retention period and, in step 402, the record codes may be transferred to a record code assignment module 314 for assignment to one or more records. For instance, the system (e.g., record retention engine computing platform 310) may receive one or more records (e.g., stored or archived records) in step 403. In step 404, each record may be assigned a record code indicating a retention period associated with the record code and, thus, the record to which the record code is assigned.

In step 405, the records and record codes assigned thereto may be transmitted to the record evaluation module 315. The record evaluation module may then evaluate one or more records in step 406 in FIG. 4B. As discussed above, evaluating a record may indicate retrieving a date associated with the record and determining a different between the date and a current date.

If the time difference is greater than the retention period for the record (as retrieved from the record code) the retention period for that document has expired. Accordingly, in step 407, the record evaluation module 315 may identify one or more records for which the retention period has expired. In step 408, the identified records, or identification of the records, may be transferred or transmitted to the record and information management computing platform 320.

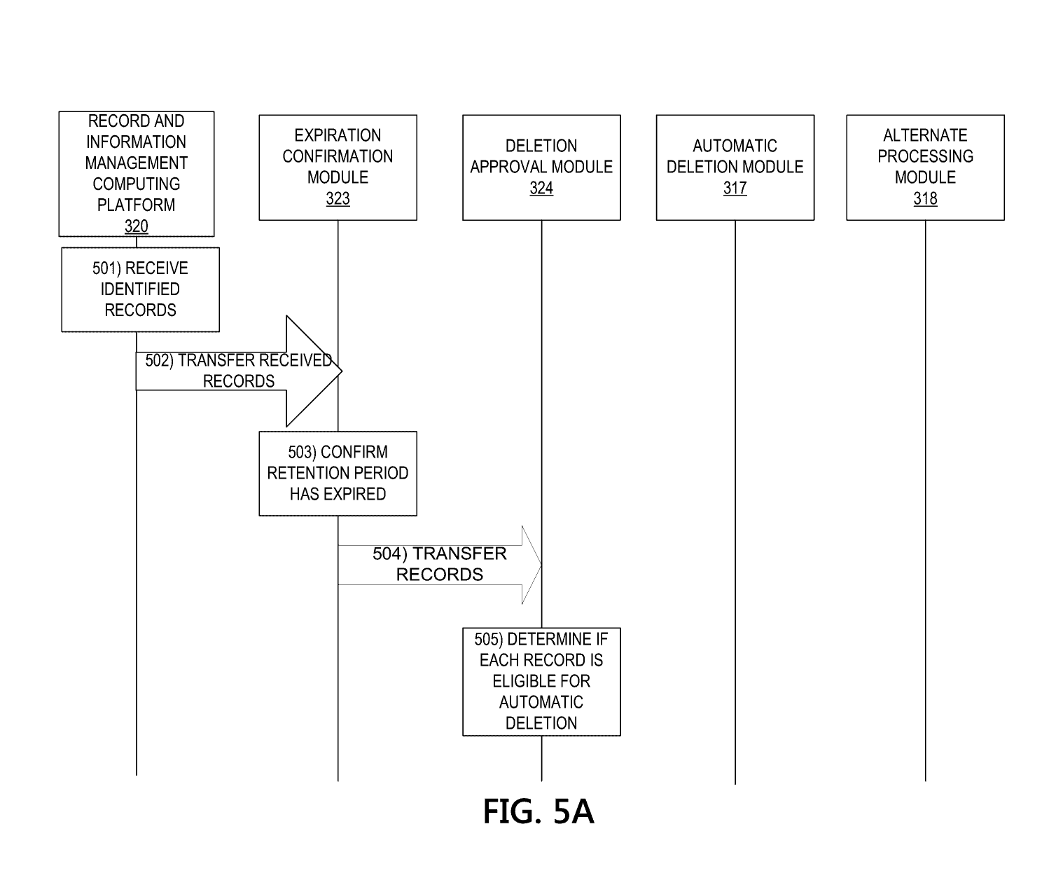

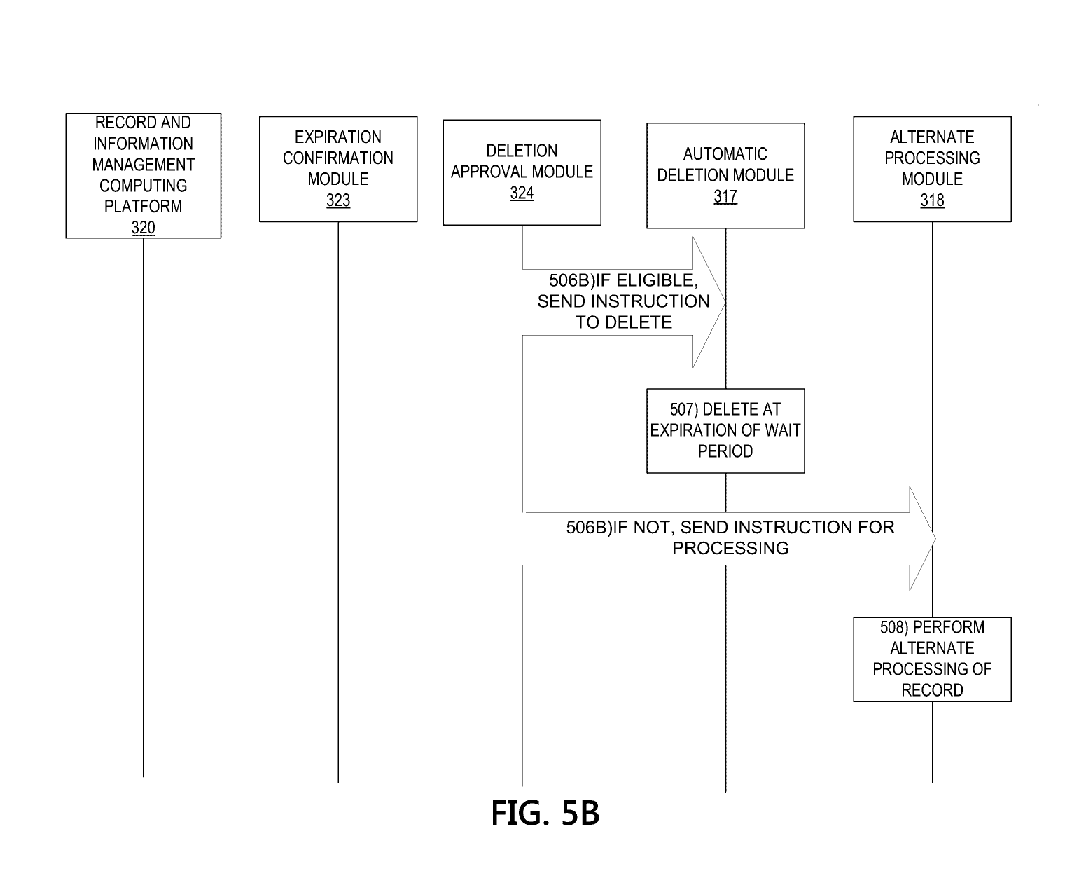

FIGS. 5A and 5B depict an illustrative event sequence for receiving records identified as having an expired retention period and processing the records for deletion according to one or more aspects described herein. It should be noted that the events shown and described with respect to FIGS. 5A and 5B are merely one example sequence and some steps may be omitted, or additional steps added, without departing from the invention.

With reference to FIG. 5A, in step 501, records identified by one or more modules of the record retention engine computing platform 310 may be received by the record and information management computing platform 320. In step 502, the identified records may be transferred or transmitted to the expiration confirmation module 323. Accordingly, the expiration confirmation module 323 may confirm that the retention period for a particular record has expired in step 503.

In step 504, the records may be transferred to the deletion approval module 324. In step 505, the deletion approval module 324 may determine whether the record is eligible for automatic deletion. For instance, the deletion approval module 324 may determine whether a flag or hold has been placed on the record. If the record is eligible for automatic deletion, in step 506A, an instruction may be transmitted to the automatic deletion module 317 of the record retention engine computing platform 310, as shown in FIG. 5B. The record may then be deleted. In some examples, the record may be held for a predefined period of time prior to deletion, as shown in step 507. This may provide an opportunity for a system administrator or other user to confirm deletion prior to deletion, if desired. At the expiration of the predefined time period, the record may be automatically deleted (e.g., a deletion procedure may be executed). If the record is not eligible for automatic deletion, an instruction may be transmitted to the alternate processing module 318 of the record retention engine computing platform in step 506b. In step 508, alternate processing of the record may be performed. For instance, the record may be reviewed manually to determine whether it may be deleted. In another example, the record may be stored for a predetermined time period and reviewed upon expiration of that time period. In yet another example, any record not eligible for automatic deletion may be added to a log or report and the system may review the log or report on a periodic basis to determine whether each record may or should be deleted. Various other types of alternate processing may be performed without departing from the invention.

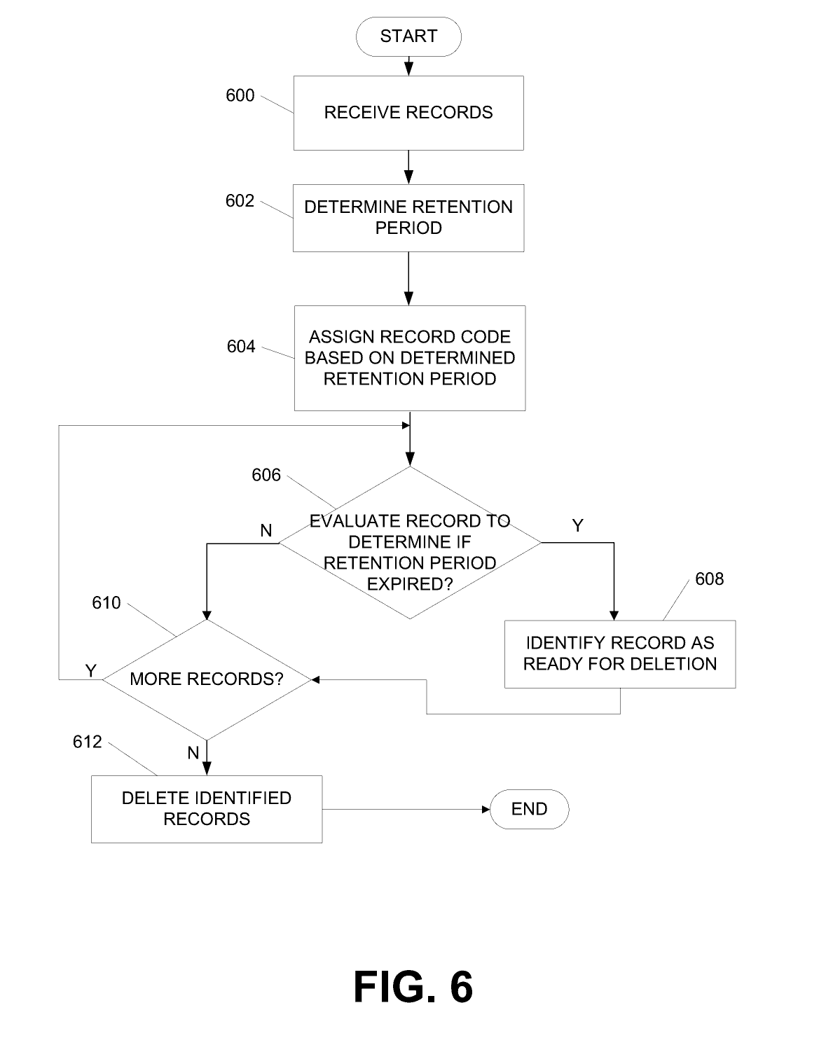

FIG. 6 illustrates one example method of identifying one or more records for which a retention period has expired, according to one or more aspects described herein. In step 600, a plurality of records may be received. As discussed above, records may include documents, databases, data tables, or other types of data which may be stored, archived or retained for a predefined retention period.

In step 602, a retention period for each record may be determined based on the type of record, content of the record, business unit who generated the record, and the like. In step 604, a record code may be assigned to each record based on the determined retention period. The record code may be stored with the record and may provide an indication of the retention period or time period for which the record should or will be retained prior to deletion.

In step 606, a record may be evaluated to determine whether a retention period for the document has expired. For instance, as discussed herein, a date associated with the record (e.g., an archive date, a date indicated in the content of the record, an adjusted archive date, or the like) may be retrieved or determined and the system may determine a time difference between the date and a current date. If the time difference is greater than the retention period (as determined from the retention code) for the record, the retention period will be deemed expired and, in step 608, the record may be identified as ready for deletion or identified as having an expired retention period. The process may then move to step 610 in which a determination is made as to whether there are additional records for evaluation. If so, the process may return to step 608 to evaluate another record.

If, in step 606, the retention period has not expired (e.g., the time difference determined is less than the retention period) then the system will continue to store the record and the process may move to step 610 in which a determination is made as to whether there are additional records for evaluation. If so, the process may return to step 606 to evaluate another record.

If, in step 610, there are no additional records for evaluation, the system may, in step 612, automatically delete any records identified as eligible for automatic deletion.

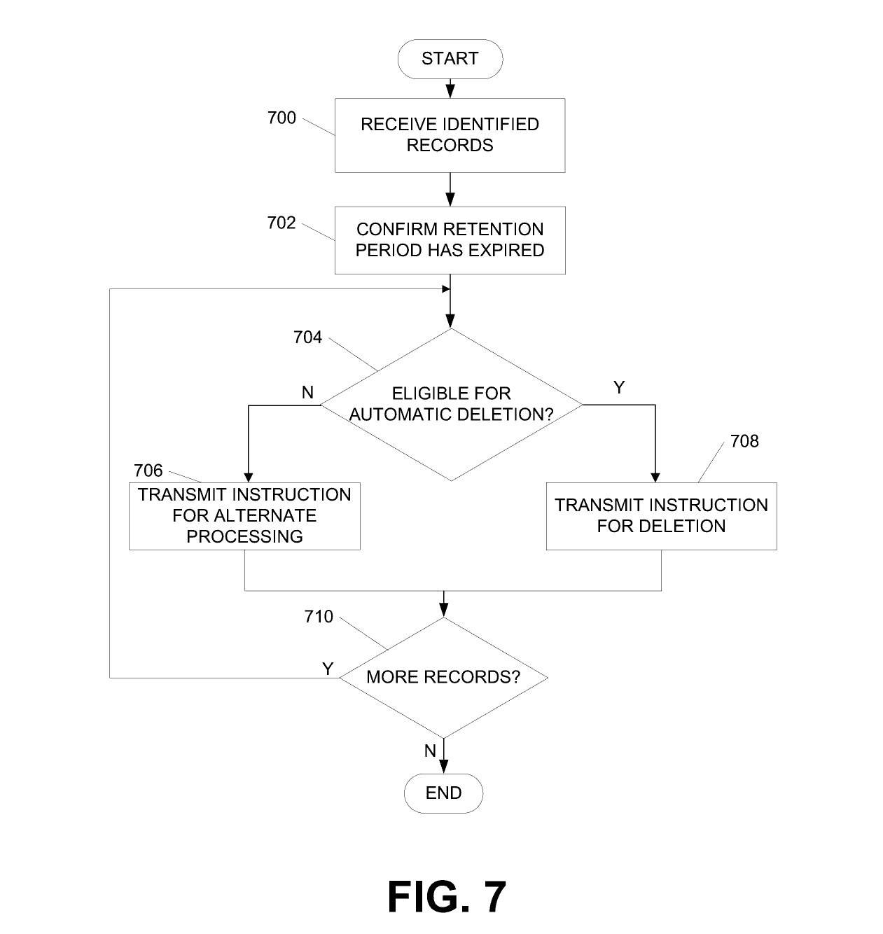

FIG. 7 illustrates one example method of deleting or further processing records for which a retention period has expired, according to one or more aspects described herein. In step 700, records identified has having an expired retention period may be received (e.g., by a record and information management computing platform). In step 702, the system may confirm that the retention period has expired.

In step 704, a determination may be made as to whether a record is eligible for automatic deletion. If so, an instruction may be transmitted (e.g., to the record retention engine computing platform) to automatically delete the record (e.g., execute a deletion procedure to permanently remove the record from the system) in step 708. If the record is not eligible for automatic deletion, an instruction may be transmitted to perform further processing using one or more alternate processing techniques described herein, in step 706.

The process may then move to step 710 in which a determination may be made as to whether there are additional records to evaluate for automatic deletion. If so, the process may return to step 704 to evaluate another record. If not, the process may end.

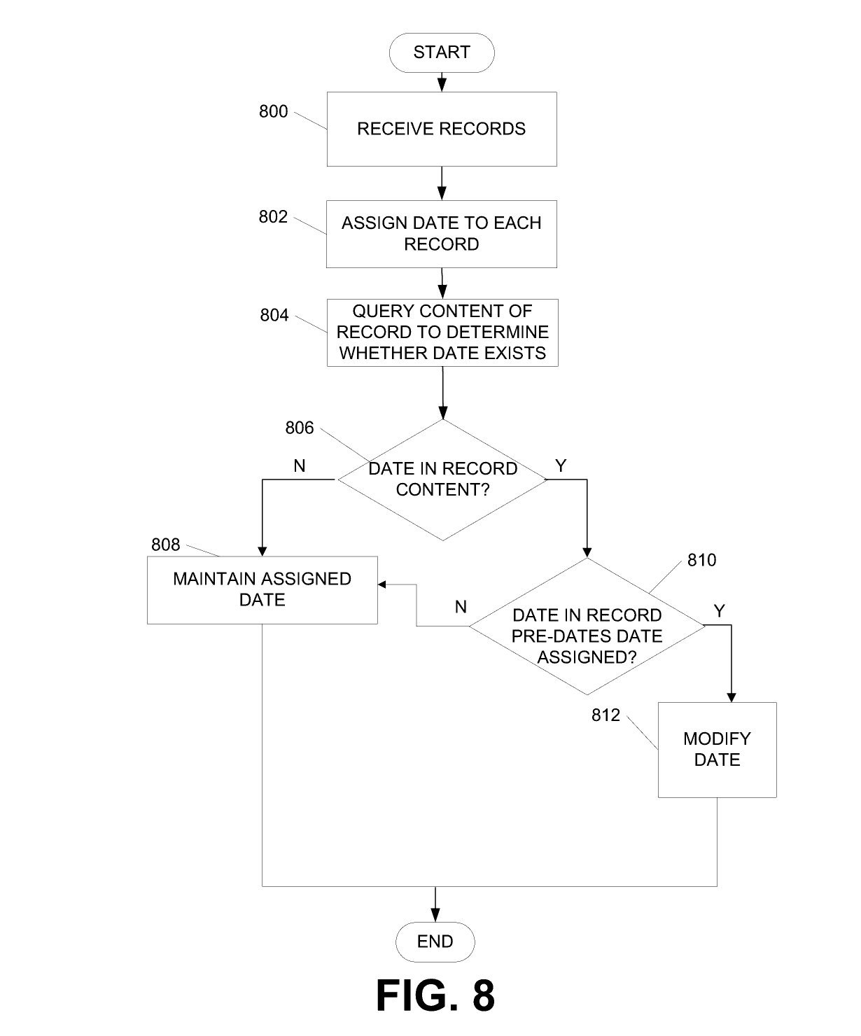

FIG. 8 illustrates one example method of evaluating and potentially modifying a date associated with a record in accordance with one or more aspects described herein. In step 800, one or more records may be received (e.g., by the record retention engine computing platform).

In step 802, a date may be assigned to each record. In some examples, the date assigned to each record may be the date on which the record was added (e.g., archived, uploaded, or the like) to the record retention engine computing platform.

In step 804, the record retention engine computing platform may query each record to determine whether date content exists in the record. In step 806, a determination is made as to whether date content exists in the record. If not, the assigned date may be maintained in step 808.

If date content does exist, a determination may be made at step 810 as to whether the date content in the record pre-dates the date assigned to the record. If so, the date may be modified to the earlier date in step 812. If not, the assigned date may be maintained in step 808.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers or platforms and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system, comprising:
a record retention engine computing platform having:
at least a first processor;
a first communication interface communicatively coupled to the at least a first processor; and
a first memory storing computer-readable instructions that, when executed by the at least a first processor, cause the record retention engine computing system to:
receive a plurality of records, each record of the plurality of records having a date associated therewith;
identify, for each record of the plurality of records, a retention period;
assign to each record of the plurality of records, a record code, the record code including the identified retention period for a respective record;
evaluate the respective record to determine, based on the record code and the date associated with the respective record, whether the retention period for the respective record has expired;
responsive to determining that the retention period has not expired, storing the respective record;
responsive to determining that the retention period for the respective record has expired, identifying the respective record as having an expired retention period and transmitting the identification of the respective record to a record and information management computing platform for further processing; and
the record and information management computing platform having:
at least a second processor
a second communication interface communicatively coupled to the at least a second processor; and
a second memory storing computer-readable instructions that, when executed by the at least a second processor, cause the record and information management computing platform to:
receive, from the record retention engine computing platform and via the second communication interface, the identification of the respective record as having an expired retention period;
determine whether the respective record identified as having an expired retention period is eligible for automatic deletion;
responsive to determining that the respective record identified as having an expired retention period is eligible for automatic deletion, transmit, to the record retention engine computing platform, an instruction to automatically delete the respective record; and
responsive to determining that the respective record identified as having an expired retention period is not eligible for automatic deletion, transmit to the record retention engine computing platform, an instruction to perform alternate processing on the respective record.

2. The system of claim 1, further including instructions that, when executed by the at least a first processor, cause the record retention engine computing platform to:
receive the instruction to automatically delete the respective record; and
automatically delete the respective record.

3. The system of claim 2, wherein automatically deleting the respective record includes holding the respective record for a predefined time period and, upon expiration of the predefined time period, executing a deletion procedure on the respective record.

4. The system of claim 1, further including instructions that, when executed by the at least a second processor, cause the record and information management computing platform to:
confirm that the retention period of the respective record identified as having an expired retention period is expired.

5. The system of claim 1, wherein evaluating the respective record to determine, based on the record code and the date associated with the respective record, whether the retention period for the respective record has expired further includes:
identifying a time difference between the date of the respective record and a current date;
determining whether the identified time difference is greater than the retention period;
responsive to determining that the identified time difference is greater than the retention period, identifying the respective record as having an expired retention period; and
responsive to determining that the identified time difference is not greater than the retention period, identifying the respective record as not having an expired retention period.

6. The system of claim 1, further including instructions that, when executed, cause the record retention engine computing platform to:
query the respective record to determine whether a date exists in content of the respective record;
responsive to determining that a date exists in the content of the respective record, determining whether the date in the content of the respective record pre-dates the date of the respective record;
responsive to determining that the date in the content of the respective record pre-dates the date of the respective record, modifying the date of the respective record to be the date in the content of the respective record.

7. The system of claim 6, further including logging the modified date of the respective record in a table of modified record dates.

8. The system of claim 6, further including instructions that, when executed, cause the record retention engine computing platform to:
responsive to determining that the date in the content of the respective record does not pre-date the date of the respective record, maintaining the date of the respective record.

8. The system of claim 1, wherein the alternate processing includes a manual review of the respective record identified as having an expired retention period prior to deletion of the record.

9. A method of identifying records having an expired retention period and processing the identified records, comprising:
at a record retention engine computing platform including at least a first processor, a first memory, and a first communication interface:
receiving, by the record retention engine computing platform, a plurality of records, each record of the plurality of records having a date associated therewith;
identifying, by the record retention engine computing platform and for each record of the plurality of records, a retention period;
assigning, by the record retention engine computing platform and to each record of the plurality of records, a record code, the record code including the identified retention period for a respective record;
evaluating, by the record retention engine computing platform, the respective record to determine, based on the record code and the date associated with the respective record, whether the retention period for the respective record has expired;
responsive to determining that the retention period has not expired, storing, by the record retention engine computing platform, the respective record;
responsive to determining that the retention period for the respective record has expired, identifying the respective record as having an expired retention period and transmitting the identification of the respective record to a record and information management computing platform for further processing; and
at the record and information management computing platform having at least a second processor, a second memory, and a second communication interface:
receiving, by the record and information management computing platform and from the record retention engine computing platform, the identification of the respective record as having an expired retention period;
determining, by the record and information management computing platform, whether the respective record identified as having an expired retention period is eligible for automatic deletion;
responsive to determining that the respective record identified as having an expired retention period is eligible for automatic deletion, transmitting, by the record and information management computing platform and to the record retention engine computing platform, an instruction to automatically delete the respective record; and
responsive to determining that the respective record identified as having an expired retention period is not eligible for automatic deletion, transmitting, by the record and information management computing platform and to the record retention engine computing platform, an instruction to perform alternate processing on the respective record.

10. The method of claim 9, further including:
receiving, by the record retention engine computing platform, the instruction to automatically delete the respective record; and
automatically delete, by the record retention engine computing device, the respective record.

11. The method of claim 10, wherein automatically deleting the respective record includes holding the respective record for a predefined time period and, upon expiration of the predefined time period, executing a deletion procedure on the respective record.

12. The method of claim 9, further including:
confirming, by the record and information management computing platform, that the retention period of the respective record identified as having an expired retention period is expired.

13. The method of claim 9, wherein evaluating the respective record to determine, based on the record code and the date associated with the respective record, whether the retention period for the respective record has expired further includes:
identifying a time difference between the date of the respective record and a current date;
determining whether the identified time difference is greater than the retention period;
responsive to determining that the identified time difference is greater than the retention period, identifying the respective record as having an expired retention period; and
responsive to determining that the identified time difference is not greater than the retention period, identifying the respective record as not having an expired retention period.

14. The method of claim 9, further including:
querying, by the record retention engine computing platform, the respective record to determine whether a date exists in content of the respective record;
responsive to determining that a date exists in the content of the respective record, determining, by the record retention engine computing platform, whether the date in the content of the respective record pre-dates the date of the respective record; and
responsive to determining that the date in the content of the respective record pre-dates the date of the respective record, modifying, by the record retention engine computing platform, the date of the respective record to be the date in the content of the respective record.

15. The method of claim 14, further including logging, by the record retention engine computing platform, the modified date of the respective record in a table of modified record dates.

16. The method of claim 14, further including:
responsive to determining that the date in the content of the respective record does not pre-date the date of the respective record, maintaining, by the record retention engine computing platform, the date of the respective record.

17. The method of claim 9, wherein the alternate processing includes a manual review of the respective record identified as having an expired retention period prior to deletion of the record.

18. One or more non-transitory computer-readable media storing instructions that, when executed by a computer system comprising at least one processor, memory, and a communication interface, cause the computer system to:
receive, by a record retention engine computing platform, a plurality of records, each record of the plurality of records having a date associated therewith;
identify, by the record retention engine computing platform and for each record of the plurality of records, a retention period;
assign, by the record retention engine computing platform and to each record of the plurality of records, a record code, the record code including the identified retention period for a respective record;
evaluate, by the record retention engine computing platform, the respective record to determine, based on the record code and the date associated with the respective record, whether the retention period for the respective record has expired;
responsive to determining that the retention period has not expired, store, by the record retention engine computing platform, the respective record;
responsive to determining that the retention period for the respective record has expired, identifying the respective record as having an expired retention period and transmit the identification of the respective record to a record and information management computing platform for further processing;
receive, by the record and information management computing platform and from the record retention engine computing platform, the identification of the respective record as having an expired retention period;
determine, by the record and information management computing platform, whether the respective record identified as having an expired retention period is eligible for automatic deletion;
responsive to determining that the respective record identified as having an expired retention period is eligible for automatic deletion, transmit, by the record and information management computing platform and to the record retention engine computing platform, an instruction to automatically delete the respective record; and
responsive to determining that the respective record identified as having an expired retention period is not eligible for automatic deletion, transmit, by the record and information management computing platform and to the record retention engine computing platform, an instruction to perform alternate processing on the respective record.

19. The one or more non-transitory computer-readable media of claim 18, further including instructions that, when executed, cause the computing system to:
receive, by the record retention engine computing platform, the instruction to automatically delete the respective record; and
automatically delete, by the record retention engine computing device, the respective record.

20. The one or more non-transitory computer-readable media of claim 19, wherein automatically deleting the respective record includes holding the respective record for a predefined time period and, upon expiration of the predefined time period, executing a deletion procedure on the respective record.
